(19) United States
(12) Patent Application Publication
(10) Pub. No.: US 2025/0001459 A1
(43) Pub. Date: Jan. 2, 2025

(54) WASTE SORTING ROBOT

(71) Applicant: MP ZenRobotics OY, Vantaa (FI)

(72) Inventor: Harri Holopainen, Espoo (FI)

(21) Appl. No.: 18/704,818

(22) PCT Filed: Oct. 24, 2022
(86) PCT No.: PCT/EP2022/079600

§ 371 Date: Apr. 25, 2024

(30) Foreign Application Priority Data
Oct. 26, 2021 (SE) 2130289-8

(51) Int. Cl. B07C 5/34; B25J 9/00; B25J 9/02; B25J 15/06

(52) U.S. Cl. CPC B07C 5/34; B25J 9/0093; B25J 9/026; B25J 15/06; B07C 2501/0054; B07C 2501/0063

(57) ABSTRACT

A waste sorting robot (100) comprises a frame (120) and a manipulator (104) moveably mounted to the frame (120) and comprising a gripper (132) for interacting with one or more waste objects (106b) to be sorted within a working area (108). A conveyor (110) is arranged to move the one or more waste objects (106b) towards the working area (108). At least one vacuum conduit (220) has a suction mouth (212) and is connected to a vacuum source (214). The at least one vacuum conduit (220) is configured to convey one or more sorted waste objects (106b) from the working area (108). The manipulator (104) is configured to move the gripper to a position near the suction mouth (212) after the gripper has picked the one or more waste objects (106b).

### BACKGROUND

### Field

The present disclosure relates to a waste sorting robot for sorting waste objects.

### Description of Related Art

It is known to sort domestic and industrial waste in different ways. For many years waste has been manually sorted by hand on a conveyor belt. However hand sorting waste can be arduous and dangerous to the human sorter depending on the type of industrial or domestic waste being sorted. Furthermore, some waste sorting plants which use human sorters require multiple shifts in order to increase the output of sorted waste.

One approach for improving the safety and the output of waste sorting is to automate one or more aspects of the waste sorting. The automation can comprise a controller sending control and movement instructions to a manipulator for interacting with the physical objects. The combination of a controller sending control instructions to a manipulator can also be referred to as a “robot”.

One known waste sorting robot is shown in international patent application WO2019215384 which shows a waste sorting robot with a manipulator moveable on the gantry frame in three orthogonal directions actuated with a servo for each orthogonal direction. The manipulator comprises a suction gripper for gripping and sorting waste objects. The suction gripper is able to grip, throw and sort different types of objects in to different fractions into a chute. For example, the waste sorting robot can sort the waste objects such as plastic containers, foils, plastics wrappers etc.

When the suction gripper picks a light, flexible material such as a plastic bag or a foil, the suction gripper is not able to throw the waste object. This is because the aerodynamic properties of foils and wrappers is unpredictable. Instead, the manipulator must position the suction gripper directly over the chute and let the light, flexible material float down into the chute. This increases the overall time of picking waste objects and reduces the throughput of the waste sorting robot.

### SUMMARY

Examples of the present disclosure aim to address the aforementioned problems.

According to an aspect of the present disclosure, there is a waste sorting robot comprising: a frame; a manipulator moveably mounted to the frame and comprising a gripper for interacting with one or more waste objects to be sorted within a working area; and a conveyor for moving the one or more waste objects towards the working area; at least one vacuum conduit having a suction mouth and being connected to a vacuum source, the at least one vacuum conduit being configured to convey one or more sorted waste objects from the working area; wherein the manipulator is configured to move the gripper to a position near the suction mouth after the gripper has picked the one or more waste objects.

Optionally, the suction mouth is configured to move together with the manipulator.

Optionally, the suction mouth is fixed with respect to the frame and/or the working area.

Optionally, the suction mouth is positioned in a chute configured to receive the one or more sorted objects released from the gripper.

Optionally, the suction mouth is positioned above or adjacent to the working area.

Optionally, the suction mouth comprises a diameter similar to or greater than the width or length of the working area.

Optionally, the suction mouth is fixed with respect to the manipulator and/or the gripper.

Optionally, the vacuum conduit comprises a flexible portion configured to move together with the manipulator and/or the gripper.

Optionally, the manipulator is mounted to the frame on a moveable sled configured to move the manipulator across the width of the working area and the suction mouth or a part of the vacuum conduit is mounted to the moveable sled.

Optionally, the manipulator is mounted to the frame on a moveable beam configured to move the manipulator along the length of the working area and the suction mouth or a part of the vacuum conduit is mounted to the moveable beam.

Optionally, the vacuum source is configured to be selectively actuated in dependence of the operational status of the gripper and/or the manipulator.

Optionally, the vacuum source is configured to be selectively actuated in dependence of one or more parameters of the one or more waste objects picked by the gripper.

Optionally, the vacuum source is configured to be selectively actuated in dependence of the type of the one or more waste objects picked by the gripper.

Optionally, the type of the one or more waste objects is paper, foil, film, threads, fibres, string, or other flexible layer material or flexible thread material.

Optionally, the vacuum source is configured to be actuated when the manipulator and/or the gripper is actuated.

Optionally, at least part of the gripper or the manipulator is mounted within the suction mouth and the gripper is configured to move from a position within the suction mouth to a position near the working area when picking the one or more waste objects.

Optionally, the waste sorting robot comprises a second manipulator coupled to the vacuum conduit such that the suction mouth moves with respect to the working area.

Optionally, the gripper is a suction gripper.

Optionally, at least a portion of the manipulator is rotatable with respect to the frame such that the gripper is moveable lengthways along the conveyor within the working area.

Optionally, the portion of the manipulator is rotatable about a horizontal axis perpendicular to the longitudinal axis of the conveyor.

Optionally, the manipulator is pivotally mounted on a cross beam over the conveyor.

In another aspect of the disclosure there is provided a waste sorting robot comprising: a frame; a manipulator moveably mounted to the frame and configured to interact with one or more waste objects to be sorted within a working area; and a conveyor for moving the one or more waste objects towards the working area; a vacuum conduit having a suction mouth and being connected to a vacuum source and, the vacuum conduit being configured to convey one or more sorted objects away from the working area; wherein the manipulator is coupled to the vacuum conduit and configured to move the suction mouth within the working area such that the suction mouth is configured to pick the one or more waste objects from the working area.

### BRIEF DESCRIPTION OF THE DRAWINGS

Various other aspects and further examples are also described in the following detailed description and in the attached claims with reference to the accompanying drawings, in which:

FIG. 1 shows a perspective schematic view of the waste sorting robot according to an example;

FIG. 2 shows a schematic view of a waste sorting robot according to an example;

FIG. 3 shows a side view of the waste sorting robot and manipulator according to an example;

FIG. 4 shows a side view of the waste sorting robot and manipulator according to an example;

FIG. 5 shows a side view of the waste sorting robot and manipulator according to an example;

FIG. 6 shows a perspective view of a waste sorting robot according to an example;

FIG. 7 shows a side view of the waste sorting robot and manipulator according to an example;

FIG. 8 shows a perspective view of a waste sorting robot according to an example;

FIG. 9 shows a perspective view of a waste sorting robot according to an example; and

FIG. 10 shows a side view of the waste sorting robot and manipulator according to an example.

### DETAILED DESCRIPTION

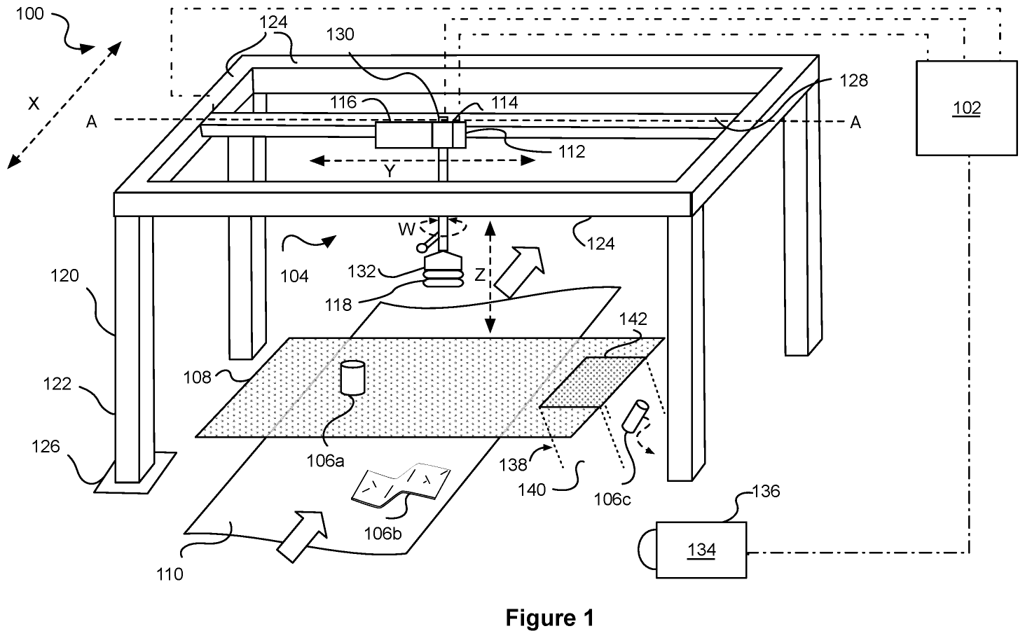

FIG. 1 shows a schematic perspective view of a waste sorting robot 100. In some examples, the waste sorting robot 100 can be a waste sorting gantry robot 100. In other examples other types of waste sorting robots can be used such as delta robots. For the purposes of brevity, the examples will be described in reference to waste sorting gantry robots but can also be other types of robot such as robot arms or delta robots. Alternatively, the waste sorting robot is a SCARA robot which has a rotary joint that moves the manipulator along the travelling direction of the belt.

For the purposes of brevity, the examples will be described in reference to waste sorting gantry robots 100 as shown in the Figures, but any of the other aforementioned robot types can be used instead or in addition to the waste sorting robot 100. Hereinafter the term waste sorting robot 100 will be used to describe the arrangements shown in the Figures.

The waste sorting robot 100 comprises a controller 102 for sending control and movement instructions to a manipulator 104 for interacting with the physical objects 106a, 106b, 106c. The combination of a controller sending control instructions to a manipulator can also be referred to as a “robot”. The controller 102 is located remote from the manipulator 104 and is housed in a cabinet (not shown). In other examples, the controller 102 can be integral with the manipulator and/or a frame 120.

The manipulator 104 physically engages and moves the objects 106a, 106b, 106c that enters the working area 108. The working area 108 of a manipulator 104 is an area within which the manipulator 104 is able to reach and interact with the object 106a 106b, 106c. The working area 108 as shown in FIG. 1 is projected onto a conveyor 110 for the purposes of clarity. The manipulator 104 is configured to move at variable heights above the working area 108. In this way, the manipulator 104 is configured to move within a working volume defined by the height above the working area 108 where the robot can manipulate an object. The manipulator 104 comprises one or more components for effecting relative movement with respect to the objects 106a, 106b, 106c. The manipulator 104 will be described in further detail below.

The physical objects 106a, 106b, 106c are moved into the working area 108 by the conveyor 110. The path of travel of the conveyor 110 e.g. a conveyor belt 110 intersects with at least a portion of the working area 108. In some examples, manipulator 104 can move over the entire working area 108. In other examples, the manipulator 104 can move through a portion of the working area 108 and a plurality of waste sorting robots 100 operate within the working area 108. For example, two waste sorting robots 100 can cover the entire conveyor belt 110. This means that every object 106a, 106b, 106c that is moving on the conveyor belt 110 will pass through the working area 108. The conveyor belt 110 can be a continuous belt, or a conveyor belt formed from overlapping portions. The conveyor belt 110 can be a single belt or alternatively a plurality of adjacent moving belts.

In other examples, the physical objects 106a, 106b, 106c can be conveyed into the working area 108 via other conveying means. The conveyor can be any suitable means for moving the objects 106a, 106b, 106c into the working area 108. For example, the objects 106a, 106b, 106c are fed under gravity via slide (not shown) to the working area 108. In other examples, the objects can be entrained in a fluid flow, such as air or water, which passes through the working area 108.

The direction of the conveyor belt 110 is shown in FIG. 1 by two arrows. The objects 106a, and 106b are representative of different types of objects to be sorted having not yet been physically engaged by the manipulator 104. In contrast, the object 106c is an object that has been sorted into a particular type of object. In some examples, the manipulator 104 interacts with only some of the objects 106c. For example, the waste sorting robot 100 is only removing a particular type of object such as plastic PET containers. In other scenarios, the manipulator 104 will interact and sort every object 106a, 106b, 106c which is on the conveyor belt 110.

In some examples, the objects to be sorted are waste products. The waste products can be any type of industrial, commercial, domestic waste or any other waste which requires sorting and processing. Unsorted waste material comprises a plurality of fractions of different types of waste. Industrial waste can comprise fractions, for example, of metal, wood, plastic, hardcore and one or more other types of waste. In other examples, the waste can comprise any number of different fractions of waste formed from any type or parameter of waste. The fractions can be further subdivided into more refined categories. For example, metal can be separated into steel, iron, aluminium etc. Domestic waste also comprises different fractions of waste such as plastic, paper, cardboard, metal, glass and/or organic waste.

A fraction is a category of waste that the waste can be sorted into by the waste sorting robot 100. A fraction can be a standard or homogenous composition of material, such as aluminium, but alternatively a fraction can be a category of waste defined by a customer or user.

In some examples, the waste can be sorted according to any parameter. A non-limiting list of parameters for dividing unsorted waste into fractions is as follows: material, previous purpose, shape, size, weight, colour, opacity, economic value, purity, combustibility, whether the objects are ferrous or any other variable associated with waste objects. In a further example, a fraction can comprise one or more other fractions. For example, one fraction can comprise a paper fraction, a cardboard fraction, and a wood fraction to be combinable to be a combustible fraction. In other examples, a fraction can be defined based on the previous purpose of the waste object, for example plastic tubes used for silicone sealant. It may be desirable to separate out some waste objects because they are contaminated and cannot be recycled.

The objects are fed from a hopper or other stored source of objects onto the conveyor belt 110. Alternatively, the waste objects are fed from another conveyor belt (not shown) and there is no source of stored waste objects. In this case, the additional conveyor belt can be fed manually from e.g. an excavator. Optionally, the objects 106a, 106b, 106c can be pre-processed before being placed on the conveyor belt. For example, the objects can be washed, screened, crushed, ripped, shaken, vibrated to prepare the material before sorting. Alternatively, the waste objects 106a, 106b, 106c can be sorted with another robot or mechanical device. The objects 106a, 106b, 106c can be optionally pre-sorted before being placed on the conveyor belt 110. For example, ferrous material can be removed from the unsorted waste by passing a magnet in proximity to the conveyor belt 110. Large objects can be broken down into pieces of material which are of a suitable size and weight to be gripped by the manipulator 104.

The manipulator 104 is configured to move within the working area 108 and the working volume. The manipulator 104 comprises one or more drive mechanisms 112, 114, 116 for moving the manipulator 104 in one or more axes. The drive mechanisms 112, 114, 116 can be servos, pneumatic actuators, rack and pinion mechanisms, belt drives or any other suitable means for moving the manipulator 104 in one or more directions. In some examples, the manipulator 104 comprises one or more servos for moving the manipulator 104 in one or more axes. In some other examples, the manipulator 104 comprises one or more pneumatic actuators for moving the manipulator 104 in one or more axes. In some further examples, the manipulator 104 comprises a combination of one or more servos and one or more pneumatic actuators for moving the manipulator 104 in one or more axes. In some examples, the manipulator 104 is moveable along a plurality of axes.

In some examples, the manipulator 104 is moveable along three axes which are substantially at right angles to each other. For example as shown in FIG. 1, the manipulator 104 is movable in an X-axis which is parallel with the longitudinal axis of the conveyor belt 110 (“beltwise” or “lengthways”). When the manipulator 104 is described below as moving in the X-axis, this may also be referred to moving “along” the length of the working area 108 in the X-axis direction. Additionally, the manipulator 104 is movable across the conveyor belt 110 in a Y-axis which is perpendicular to the longitudinal axis of the conveyor belt 110 (“widthwise”). When the manipulator 104 is described below as moving in the Y-axis, this may also be referred to moving “across” the width of the working area 108 in the Y-axis direction. The manipulator 104 is also movable in a Z-axis which is in a direction normal to the working area 108 and the conveyor belt 110 (“heightwise”).

Optionally, the manipulator 104 can rotate about one or more axes. In some examples a suction gripper 132 or other suitable gripper coupled to the manipulator 104 can rotate about a W-axis. The suction gripper 132 or other suitable gripper is discussed in further detail below.

The directions of movement of the manipulator 104 within the working space along the X-axis, Y-axis and the Z-axis are shown by the two headed arrows with dotted lines in FIG. 1. The manipulator 104 is moved with respect to the conveyor belt 110 by an X-axis drive mechanism 112, a Y-axis drive mechanism 114 and a Z-axis drive mechanism 116 respectively along the X-axis, the Y-axis, and the Z-axis.

The X-axis, Y-axis, and Z-axis drive mechanisms 112, 114, 116 are connected to the controller 102 and the controller 102 is configured to issue instructions for actuating one or more X-axis, Y-axis, and Z-axis drive mechanisms 112, 114, 116 to move the manipulator 104 within the working area 108. The connections between the X-axis, Y-axis, and Z-axis drive mechanisms 112, 114, 116 and the controller 102 are represented by dotted lines. Each connection between the X-axis, Y-axis, and Z-axis drive mechanisms 112, 114, 116 and the controller 102 can comprises one or more data, power, and/or pneumatic connections.

As shown in FIG. 1, the manipulator 104 is mounted on a frame 120. In some examples, the frame 120 can be a gantry frame 120 as shown in FIG. 1. In other examples, the frame 120 can be other structures suitable for supporting the manipulator 104 above the working area 108. For example, the frame 120 can be a structure for suspending the manipulator 104 above the working area 108 with rods and/or cables from a ceiling, wall, or other structure. Hereinafter, the frame 120 will simply be referred to as a frame 120 but can be applicable to gantry frames or other frames for supporting the manipulator 104.

The frame 120 comprises vertical struts 122 which engage with the floor or another substantially horizontal surface. In some examples, the vertical struts 122 can be tilted upright struts. In this way, the tilted upright struts are angled to the vertical. The tilted upright struts may be required to mount the frame 120 to the floor in a non-standard installation.

FIG. 1 shows the frame 120 comprising four vertical struts 122 coupled together by horizontal beams 124. In other examples, the horizontal beams 124 can be tilted lateral beams 124. This may be required if the waste sorting robot 100 is being installed in a small or unusual space. In other examples, there can be any suitable number of vertical struts 122. The beams 124 and vertical struts 122 are fixed together with welds, bolts, or other suitable fasteners. Whilst the horizontal beams 124 are shown in FIG. 1 to be located above the conveyor belt 110, one or more horizontal beams 124 can be positioned at different heights. For example, one or more horizontal beams 124 can be positioned underneath the conveyor belt 110. This can lower the centre of mass of the frame 120 and make the entire waste sorting robot 100 more stable if the vertical struts 122 are not secured to the floor.

The beams 124 and the vertical struts 122 are load bearing and support the weight of the manipulator 104 and an object 106a, 106b, 106c that the manipulator 104 grasps. In some examples, the beams 124 and vertical struts 122 are made from steel but other stiff, lightweight materials such as aluminium can be used. The vertical struts 122 can each comprise feet 126 comprising a plate through which bolts (not shown) can be threaded for securing the vertical struts 122 to the floor. For the purposes of clarity, only one foot 126 is shown in FIG. 1, but each vertical strut 122 can comprise a foot 126. In other examples, there are no feet 126 or fasteners for securing the frame 120 to the floor. In this case, the frame 120 rests on the floor and the frictional forces between the frame 120 and the floor are sufficient to prevent the waste sorting robot 100 from moving with respect to the floor.

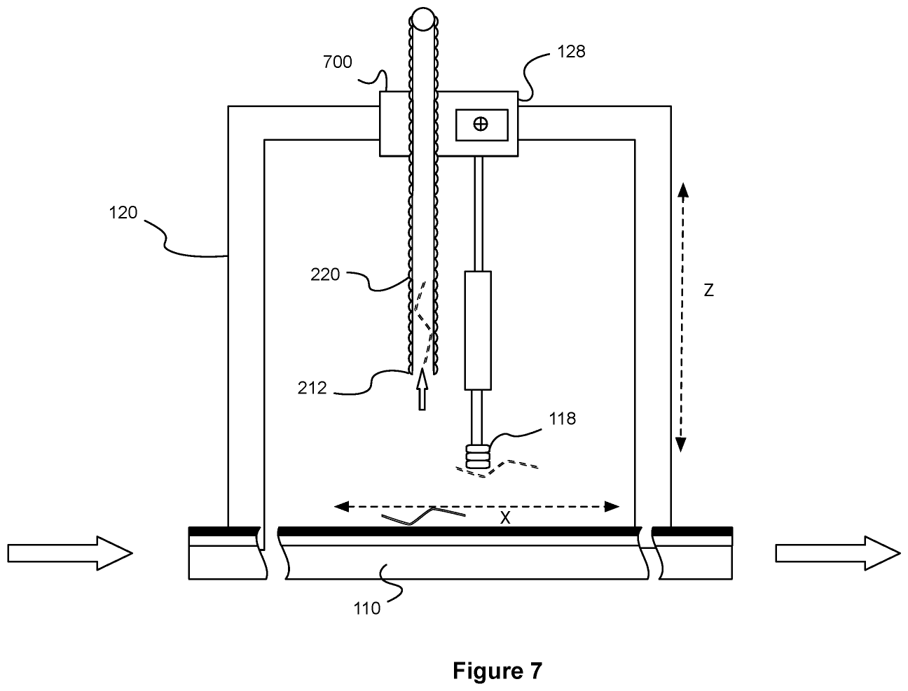

In some examples as shown in the Figures e.g. FIG. 1, the horizontal beam 128 is moveable with respect to the frame 120. In this way, the horizontal beam 128 is moveable with respect to the other fixed horizontal beams 124 in the X-axis. The moveable horizontal beam 128 can be mounted in a beam sled 700 (as best show in FIG. 7). The moveable horizontal beam 128 is movably mounted on one or more of the other fixed horizontal beams 124 of the frame 120. The horizontal beam 128 is configured to be moved in the X-axis with a servo, pneumatic actuators or any other suitable means as previously discussed above for moving the manipulator 104.

However, optionally the horizontal beam 128 is fixed with respect to the frame 120. In some examples, the manipulator 104 does not move the suction gripper 132 in the X-axis. In this example, there is no servo mounted on the frame 120 for moving the horizontal beam 128 in the X-axis.

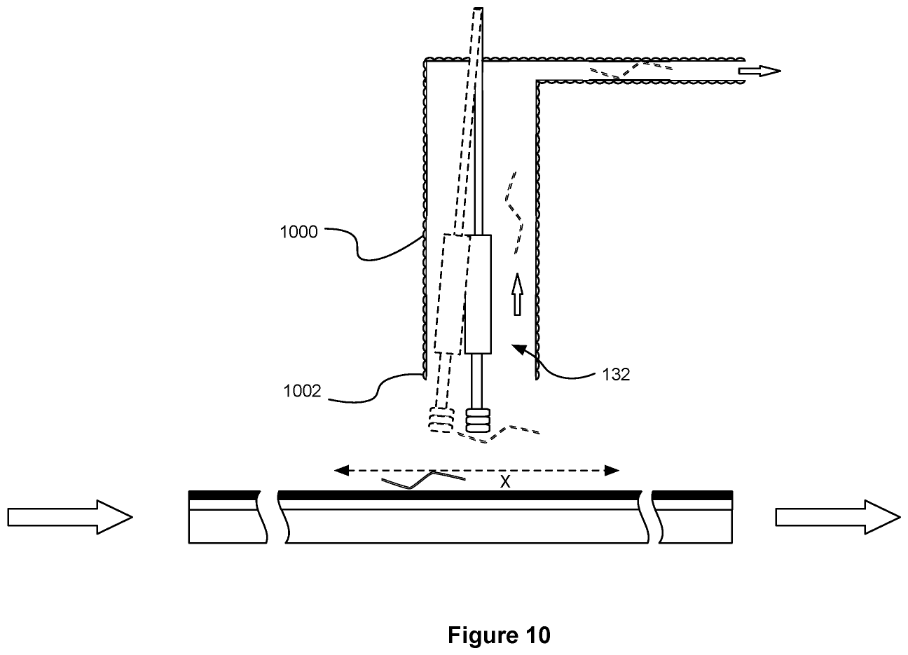

In some other examples, as mentioned below, the manipulator 104 moves the suction gripper 132 in the X-axis without moving the horizontal cross beam 128. In order to cause moves of the suction gripper 132 in the X-axis, the suction gripper 132 can be pivotally mounted to the manipulator 104 and a pneumatic actuator is coupled to the suction gripper 132 which is arranged to move in the X-axis. An example of a pivotally mounted manipulator 104 is shown in FIG. 10 which is discussed in further detail below.

Additionally or alternatively, the manipulator 104 optionally comprises at least one movable horizontal beam 128 which is movably mounted on the frame 120. For example, the horizontal beam 128 is optionally rotatable about the longitudinal axis (A-A) of the horizontal beam 128. In this way, when the horizontal beam 128 rotates, the manipulator 104 moves in the X-axis.

Hereinafter, the examples will be described with the manipulator 104 configured to be moveable in the X-axis with the moveable horizontal beam 128. However, the movement of the manipulator 104 in the X-axis can be achieved in other ways as discussed above.

Movement of the manipulator 104 in the Y-axis and Z-axis will now be discussed in further detail with reference to FIG. 1. The manipulator sled 130 is movable in the Y-axis relative to the horizontal beam 128. In some examples, the manipulator sled 130 comprises a Y-axis drive mechanism 114 for moving the manipulator sled 130 along the Y-axis. In some examples, the Y-axis drive mechanism 114 is a servo.

In other examples, the Y-axis drive mechanism 114 is not mounted in the manipulator sled 130 and manipulator sled 130 moves with respect to the Y-axis drive mechanism 114. In some examples, the Y-axis drive mechanism 114 is coupled to the horizontal beam 128 via a belt drive. In other examples, the Y-axis drive mechanism 114 is a servo which is coupled to the horizontal beam 128 via a rack and pinion mechanism. In some examples, other mechanisms can be used to actuate movement of the horizontal beam 128 along the Y-axis. For example, a hydraulic or pneumatic system can be used for moving the manipulator sled 130.

When the manipulator sled 130 moves along the Y-axis, the suction gripper 132 also moves in the Y-axis. The suction gripper 132 is movably mounted to the manipulator sled 130. The suction gripper 132 is movable in the Z-axis in order to move the manipulator 104 heightwise in the Z-axis direction.

In some examples, the suction gripper 132 comprises a Z-axis drive mechanism 116 for moving the suction gripper 132 along the Z-axis. In some examples, the Z-axis drive mechanism 116 is a pneumatic actuator 116. In other examples, the Z-axis drive mechanism 116 is a Z-axis servo. In other examples, the Z-axis drive mechanism 116 is a servo which is coupled to the manipulator sled 130 via a rack and pinion mechanism. Accordingly, when the Z-axis drive mechanism 116 is actuated and extends the suction gripper 132, the suction gripper 132 moves towards the conveyor belt 110.

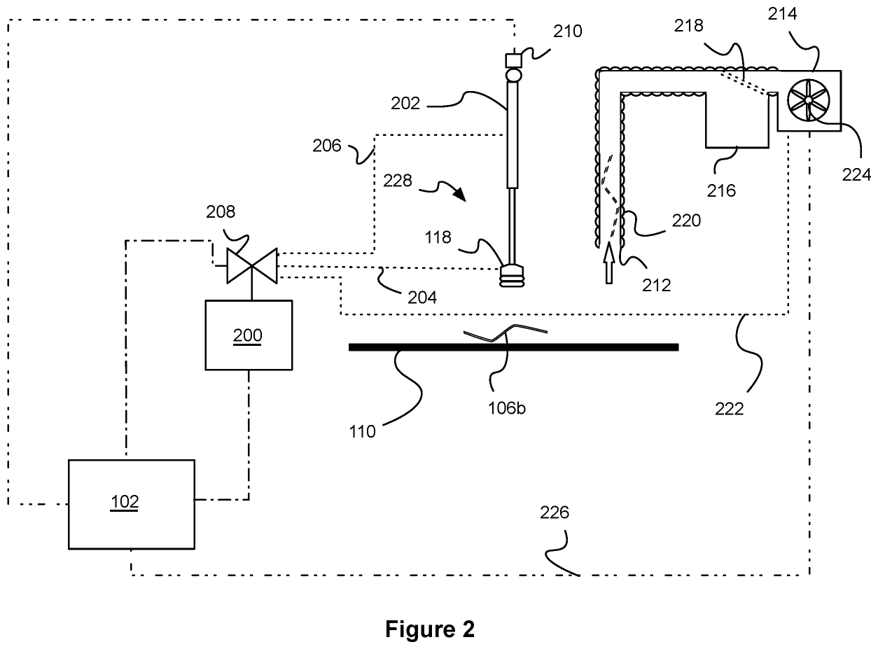

FIG. 1 show an example suction gripper 132 which will now be discussed. The suction gripper 132 can be a suction gripper having a suction cup 118 (as shown in FIG. 2) for gripping the objects using negative pressure with respect to atmospheric pressure. The suction gripper 132 is part of a suction gripper assembly 228 comprising one or more components for actuating or moving the suction gripper 132. For the purposes of clarity, reference will only be made to the suction gripper 132. The suction gripper 132 can have a suction cup 118 which is substantially symmetric about the Z-axis.

This means that the suction gripper 132 does not need to be rotated about the Z-axis to achieve an optimal orientation with respect to the objects 106a, 106b, 106c. This means that the gripper assembly rotation servo is not required with a suction gripper 132.

In the case with an asymmetrical suction gripper 132, the suction gripper 132 comprises a rotation servo or other actuator such as a pneumatic actuator (not shown) to rotate the suction gripper 132 about the W-axis as previously discussed above. Rotation of the suction gripper 132 about the W-axis is shown in FIG. 1, but the servo for causing the rotation is not shown. The suction gripper 132 can have an elongate suction cup 118. Additionally or alternatively, the suction gripper 132 can comprise a plurality of suction grippers (not shown). For example, the suction gripper 132 can comprise an asymmetrical suction gripper 132 comprising two suction tubes each with a suction cup 118.

Control of the suction gripper 132 will be discussed below in more detail with respect to FIG. 2.

In other examples (not shown in the Figures), the suction gripper 132 of the manipulator 104 additionally or alternatively comprises any suitable means for physically engaging and moving the objects 106a, 106b, 106c. Indeed, the manipulator 104 can additionally or alternatively be one or more tools for grasping, securing, gripping, cutting or skewering objects. For example, the suction gripper 132 is alternatively a pair of gripping jaws, a finger gripper, or any magic gripper. In this way, the manipulator 104 can comprise a gripper which is not a suction gripper. In further examples the manipulator 104 can additionally be a tool configured for interacting with and moving an object at a distance such as an electromagnet or a nozzle for blowing compressed air.

Turning back to FIG. 1, the control of the waste sorting robot 100 will now be discussed in further detail. As mentioned previously, the controller 102 is configured to send instructions to the X-axis, Y-axis, and Z-axis drive mechanisms 112, 114, 116 of the manipulator 104 to control and interact with objects 106a, 106b, 106c on the conveyor belt 110. The controller 102 is connected to at least one sensor 134 for detecting the objects 106a, 106b, 106c on the conveyor belt 110. The at least one sensor 134 is positioned in front of the manipulator 104 so that detected measurements of the objects 106a, 106b, 106c are sent to the controller 102 before the objects 106a, 106b, 106c enter the working area 108. In some examples, the at least one sensor 134 can be one or more of a RGB camera, an infrared camera, a metal detector, a hall sensor, a temperature sensor, visual and/or infrared spectroscopic detector, 3D imaging sensor, terahertz imaging system, radioactivity sensor and/or a laser. The at least one sensor 134 can be any sensor suitable for determining a parameter of the object 106a, 106b, 106c.

FIG. 1 shows that the at least one sensor 134 is positioned in one position. The at least one sensor 134 is mounted in a sensor housing 136 to protect the sensor 134. In other examples, a plurality of sensors are positions along and around the conveyor belt 110 to receive parameter data of the objects 106a, 106b, 106c. In some examples, the at least one sensor 134 is optionally mounted in a sensor bar which is positioned in front of the manipulator 104 on the conveyor belt 110. In this way, the sensor bar 600 detects the objects 106a, 106b, 106c to be sorted before the objects 106a, 106b, 106c enter the working area 108.

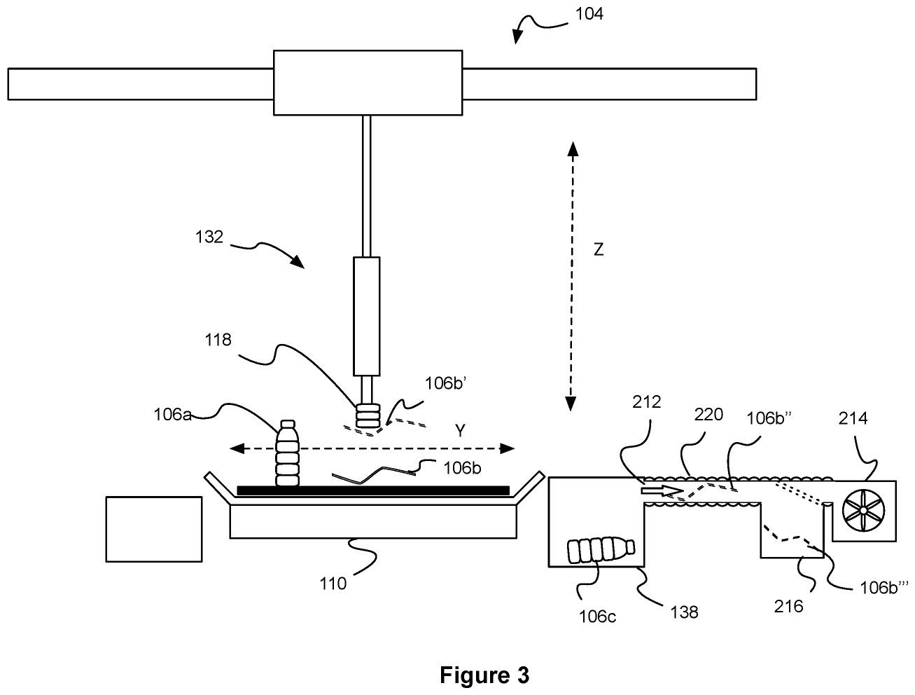

The controller 102 receives information from the at least one sensor 134 corresponding to one or more objects 106a, 106b, 106c on the conveyor belt 110. The controller 102 determines instructions for moving the manipulator 104 based on the received information according to one or more criteria. Various information processing techniques can be adopted by the controller 102 for controlling the manipulator 104. Such information processing techniques are described in WO2012/089928, WO2012/052615, WO2011/161304, WO2008/102052 which are incorporated herein by reference. The control of the waste sorting robot 100 is discussed in further detail in reference to FIG. 3 below.

Once the manipulator 104 has received instructions from the controller 102, the manipulator 104 executes the commands and moves the suction gripper 132 to pick an object 106c from the conveyor belt 110. The process of selecting and manipulating an object on the conveyor belt 110 is known as a “pick”.

Once a pick has been completed, the manipulator 104 drops or throws the object 106c into a chute 138. An object 106c dropped into the chute 138 is considered to be a successful pick. A successful pick is one where an object 106c was selected and moved to the chute 138 associated with the same fraction of waste as the object 106c. The chute 138 may be optional because the manipulator 104 may be controlled to drop the sorted object 106c into a sorted pile of objects have the same fraction or into a hole (not shown) in the floor.

In some scenarios, the picking operation may comprise gripping a waste object 106b which is a thin or light flexible material such as a film, foil, wrapper, paper, tissue, thread, string, plastic bag, plastic wrapper. FIG. 1 shows a thin flexible waste object 106b which is to be gripped by the suction gripper 132 during a picking operation. When this occurs suction gripper 132 can easily grip and lift the thin flexible waste object 106b. However, the suction gripper 132 is not able to easily throw the thin flexible waste object 106b. This is because the thin flexible waste object 106b has an unpredictable aerodynamic profile and easily deforms. Accordingly, the suction gripper 132 may need to drop the thin flexible waste object 106b when positioned above the chute 138. This means that the suction gripper 132 has to travel further when carrying out a picking operation for the thin flexible waste object 106b. This increases the duration of the picking operation and reduces the throughput of the waste sorting robot 100.

As shown in FIG. 1, the chute 138 comprises a chute opening 142 in the working area 108 for dropping picked objects 106c. The chute opening 142 of the chute 138 is adjacent to the conveyor belt 110 so that the manipulator 104 does not have to travel far when conveying a picked object 106c from the conveyor belt 110 to the chute opening 142. By positioning the chute opening 142 of the chute adjacent to the conveyor belt 110, the manipulator 104 can throw, drop, pull and/or push the object 106c into the chute 138.

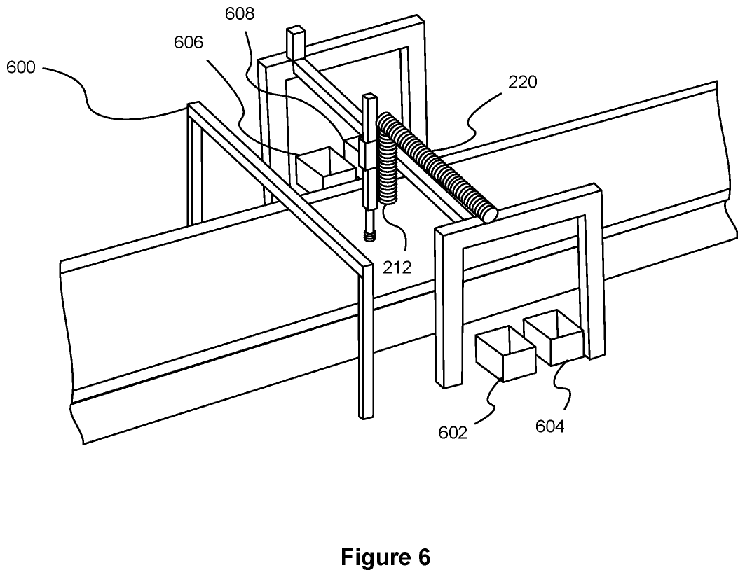

The chute 138 comprises walls 140 defining a conduit for guiding picked objects 106c into a fraction receptacle (not shown) for receiving a sorted fraction of waste. In some examples, a fraction receptacle is not required and the sorted fractions of waste are piled up beneath the chute 138. FIG. 1 only shows one chute 138 associated with the manipulator 104. In other examples, there can be a plurality of chutes 138 and associated openings 142 located around the conveyor belt 110. For example, FIGS. 6, 8 and 9 show a plurality 602, 604, 606, 608 of chutes for receiving different sorted objects 106c.

Each opening 142 of the different chutes 138 is located within the working area 108 of the manipulator 104. The walls 140 of the conduit can be any shape, size, or orientation to guide picked objects 106c to the fraction receptacle. In some examples, the successfully picked objects 106c move under the force of gravity from the chute opening 142 of the chute 138 to the fraction receptacle. In other examples, the chute 138 may guide the successfully picked objects 106c to another conveyor belt (not shown) or other means for moving the successfully picked objects 106c to the fraction receptacle.

The control of the waste sorting robot 100 will now be discussed in further detail with reference to FIG. 2. FIG. 2 shows a schematic view of the waste sorting robot 100 and manipulator 104 according to an example discussed in reference to any of the other examples.

As mentioned, one or more of the X-axis drive mechanism 112, Y-axis drive mechanism 114 and the Z-axis drive mechanism 116 can comprise a pneumatic actuator. For the purposes of clarity only a first pneumatic actuator 202 is shown in FIG. 2. The first pneumatic actuator 202 is configured to cause the movement of the manipulator 104 e.g. the suction gripper 132 in the Z-axis.

FIG. 2 shows a suction gripper 132 which is in fluid communication with a pneumatic system 200. The pneumatic system 200 comprises at least one hose 204 for connecting the suction gripper 132 to the pneumatic system 200. In some examples, the hose is an air hose or a vacuum hose 204 for providing a source of air or a vacuum source to the suction gripper 132.

Furthermore, the first pneumatic actuator 202 is in fluid communication with the pneumatic system 200. The pneumatic system 200 comprises at least one hose 206 for connecting the first pneumatic actuator 202 to the pneumatic system 200. Likewise, in examples where the manipulator 104 comprises a second pneumatic actuator (not shown) and a third pneumatic actuator (not shown) for respectively moving the manipulator 104 in the Y-axis and the X-axis, the second pneumatic actuator and the third pneumatic actuator comprise further hoses (not shown) in fluid communication with the pneumatic system 200.

The air hoses 204, 206 are flexible and threaded along the horizontal beam 128 and connected to pneumatic system 200. In some examples, (not shown) the air hoses 204, 206 can be inserted within the hollow horizontal beam 128. The air hoses 204, 206 are sufficiently flexible to move and flex so as to change shape as the manipulator 104 moves without impeding the movement of the manipulator 104.

The pneumatic system 200 can comprise an air compressor for generating a source of compressed air. Optionally, the pneumatic system 200 can also comprise an air storage tank (not shown) for compressed air. Furthermore, the pneumatic system 200 can also comprise one or more valves 208 for selectively providing air to the suction gripper 132, the first pneumatic actuator 202, and/or any other pneumatic devices connected to the pneumatic system 200. In some examples, the air compressor generates an air source having a pressure of 8 Bar. In other examples, the air source has a pressure of 5 Bar to 10 Bar. In other examples, the air source can have any suitable pressure above atmospheric pressure.

The pneumatic system 200 can be partially or wholly located remote from the waste sorting robot 100. For example, there may be a plurality of waste sorting robots 100 on a sorting line (not shown) each of which require a source of air. In this way, a single air compressor can be connected to a plurality of waste sorting robots 100 via a plurality of air hoses 204, 206 Accordingly, the pneumatic system 200 may be located between waste sorting robots 100.

The waste sorting robot 100 also comprises a vacuum conduit 220. The vacuum conduit 220 has a suction mouth 212 and the vacuum conduit 220 is in fluid communication with a vacuum source 214. The vacuum source 214 can be separate from the pneumatic system 200 and in some examples comprises a motor fan assembly 224 for generating a negative pressure at the suction mouth 212 in the vacuum conduit 220. The controller 102 is configured to issue control instructions via a data connection 226 to the vacuum source 214 to selectively actuate the vacuum source 214. Control of the vacuum source 214 by the controller 102 is discussed in more detail below.

The vacuum conduit 220 is configured to convey one or more sorted waste objects 106b from the working area 108. The vacuum conduit 220 as shown in FIG. 2 is connected to a container 216 for storing waste objects 106b. In this way, a picked waste object 106b is sucked from the working area 108 and stored in the container 216. FIG. 2 shows the vacuum source 214 which is separate from the pneumatic system 200. The controller 102 selectively actuates the vacuum source 214 to control when waste objects 106b are sucked through the vacuum conduit 220 from the working area 108. A filter screen 218 can be optionally positioned in front of the vacuum source 214 to divert the waste objects 106b into the container 216 and prevent them from clogging or damaging the vacuum source 214.

In some examples, the vacuum conduit 220 is configured to convey a waste object 106b which is a thin flexible waste object 106b. In some examples, the thin flexible waste object 106b is paper, foil, film, threads, fibres, string, or other flexible layer material or flexible thread material. This means that the vacuum conduit 220 can speed up the time taken for a picking operation for a thin flexible waste object 106b. This is because instead of moving the manipulator 104 and the suction gripper 132 over the chute 138 so that the thin flexible waste object 106b drops vertically into the chute 138, the thin flexible waste object 106b is sucked into the vacuum conduit 220 removing the thin flexible waste object 106b from the working area 108. Accordingly, the travel distance of the manipulator 104 and the suction gripper 132 can be reduced because the thin flexible waste object 106b does not have to be placed immediately over the chute 138.

Placement of the suction mouth 212 on the waste sorting robot 100 can be varied in order to vary the amount of travel distance that is required by the manipulator 104 during a picking operation for a thin flexible waste object 106b.

As mentioned above, the vacuum source 214 can be separate from the pneumatic system 200. However, in some other examples, the vacuum conduit 220 can also be part of the pneumatic system 200 and in fluid communication with the pneumatic system 200. In this way, a vacuum hose 222 is connected between the pneumatic system 200 and the vacuum conduit 220. The vacuum hose 222 is connected to a valve 208 and the controller 102 is configured to selectively actuate the valve 208 to control the negative pressure in the vacuum conduit 220. This means that the controller 102 can control actuation of the suction force at the suction mouth 212.

In some examples, waste sorting robot 100 comprises a suction gripper sensor 210 connected to the controller 102 configured to detect one or more parameters of the suction gripper 132 and/or the manipulator 104. In some examples, the suction gripper sensor 210 is a gyroscopic sensor, such as an electrical MEMS gyroscope is used as a velocity sensor. This means that the controller 102 can determine the velocity of the suction gripper 132 during operation in order to make the control of the suction gripper 132 more accurate. Additionally or alternatively, the suction gripper sensor 210 is configured to indicate a status of the first pneumatic actuator 202 e.g. the extension of the first pneumatic actuator 202 or the pressure in the suction cup 118 of the suction gripper 132. Accordingly the controller 102 can determine the status of the suction cup 118, the suction gripper 132, the first pneumatic actuator 202 or any other part of the pneumatic system 200.

As mentioned above, FIG. 2 shows a schematic cross section of the waste sorting robot 100. Operation of the pneumatic system 200 is controlled by the controller 102. This means that the controller 102 can selectively operate e.g. the air compressor or the valve 208 of the pneumatic system 200 to deliver a supply of air to the suction gripper 132, the first pneumatic actuator 202. In this way, the first pneumatic actuator 202 and/or the suction gripper 132 are connected to a single pneumatic system 200. During operation, the controller 102 controls the first pneumatic actuator 202 and/or the other pneumatic actuators in order to move the suction gripper 132 in e.g. the Z-axis. At the same time the controller 102 can issue control signals to the vacuum source 214 to selectively suck one or more waste objects 106a, 106b, 106c from the working area 108.

The controller 102 can selectively actuate the vacuum source 214 in dependence of determination of the type of waste object 106b. For example, the controller 102 will actuate the vacuum source 214 when the controller 102 determines that the waste object 106b to be picked is a thin flexible waste object 106b. The controller 102 can stop the vacuum source 214 when the controller 102 determines that the waste object 106a, 106c to be picked is not a thin flexible waste object 106b.

In some examples, however, the controller 102 does not need to selectively actuate the vacuum source 214. Instead the vacuum source 214 is always on when the manipulator 104 and the suction gripper 132 are operational. In this case, the suction mouth 212 of the vacuum conduit 220 is positioned at a distance from the working area 108. This means that the suction force from the suction mouth 212 does not interfere with waste objects 106a, 106b, 106c still on the conveyor belt 110. Accordingly, the vacuum conduit 220 will only convey the waste objects 106a, 106b, 106c from the working area 108 when the suction gripper 132 gripping the waste object 106b is moved within a defined distance of the suction mouth 212.

Whilst the Figures show the vacuum conduit 220 is configured to be used to convey a thin flexible waste object 106b, in other examples, the vacuum conduit 220 can be used to convey any type of waste object 106a, 106b, 106c. The vacuum conduit 220 should have sufficient dimensions and suction force to convey the picked waste object 106a, 106b, 106c. For example, a vacuum conduit 220 configured to convey plastic PET bottles will have different dimensions to a vacuum conduit 220 configured to convey a thin flexible waste object 106b. This means that the position of a chute 138 adjacent to a working area 108 can be used to sort two different types of waste object 106a, 106b, 106c. Hereinafter, the vacuum conduit 220 will be discussed in reference to conveying a thin flexible waste object 106b, but the vacuum conduit 220 can be used to convey any type of waste object 106a, 106b, 106c.

Different positions of the vacuum conduit 220 and suction mouth 212 will be discussed in reference to FIGS. 3 to 10 below.

Turning to FIG. 3, a first example will now be discussed. FIG. 3 shows a waste sorting robot 100 having a vacuum conduit 220 for sucking waste objects 106b from the working area 108. FIG. 3 shows a side view of the waste sorting robot 100 across the conveyor belt 110 e.g. in the plane parallel with the Z-axis and the Y-axis. The vacuum conduit 220 is integrated into the top of the chute 138. Whilst FIG. 3 shows the vacuum conduit 220 mounted at the top of the chute 138, the vacuum conduit 220 can be mounted to the chute 138 at any position on the chute 138. It may be advantageous to mount the vacuum conduit 220 at the top of the chute 138 because this means the thin flexible waste object 106b does not enter the chute 138 and other waste objects 106c already in the chute 138 will not be sucked into the suction mouth 212. This means that when the thin flexible waste object 106b is dropped above or near the chute 138, the airflow caused by the negative pressure in the vacuum conduit 220 draws thin flexible waste object 106b into the suction mouth 212.

FIG. 3 shows the thin flexible waste object 106b in different positions. The first position is on the conveyor 110 before the suction gripper 132 has gripped and lifted the thin flexible waste object 106b. Subsequent positions of the thin flexible waste object 106b′, 106b″, 106b′″ are illustrated with dotted outlines. The thin flexible waste object 106b′ is lifted by the suction gripper 132 and moved over the conveyor 110 to the vicinity of the chute 138. The thin flexible waste object 106b″ is then sucked into the vacuum conduit 220 and thin flexible waste object 106b′″ is finally stored in the container 216. The container 216 may be option and replace with another chute (not shown) for creating a pile of sorted thin flexible waste objects 106b.

In the arrangement as shown in FIG. 3, the vacuum conduit 220 and the suction mouth 212 are fixed with respect to the frame 120 and the working area 108. This may be advantageous because existing waste sorting robots 100 can be retrofitted with systems for quickly removing thin flexible waste object 106b from the working area 108.

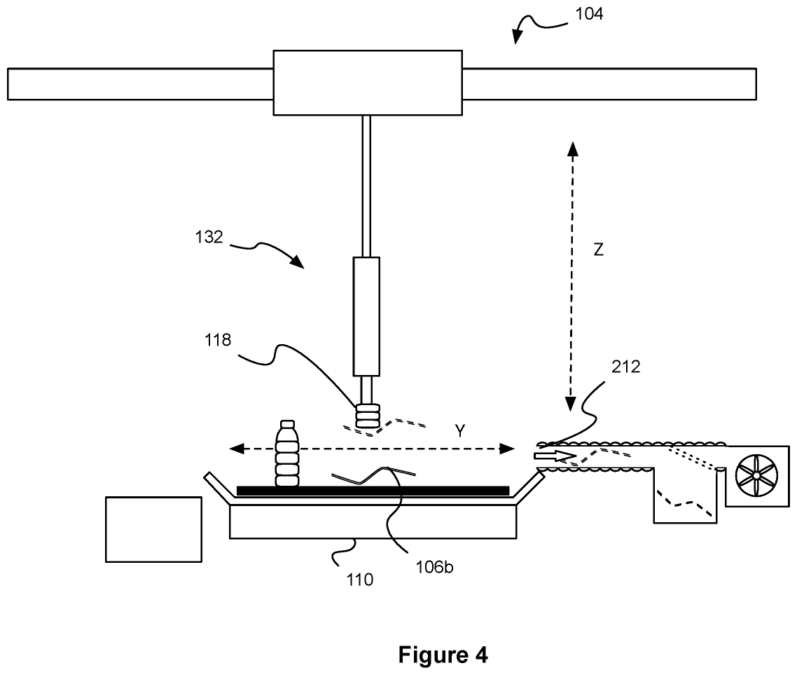

Turning to FIG. 4, another example will now be discussed. FIG. 4 shows a waste sorting robot 100 having a vacuum conduit 220 for sucking waste objects 106b from the working area 108. The example as shown in FIG. 4 is the same as shown in FIG. 3 except that the suction mouth 212 and the vacuum conduit 220 is mounted above or adjacent to the working area 108. In this example, the vacuum conduit 220 and suction mouth 212 are not integrated into the chute 138. By placing the vacuum conduit 220 and suction mouth 212 adjacent to the working area 108, the travel distance of the manipulator 104 is reduced because the manipulator 104 does not have to position over the chute 138 away from the conveyor belt 110. Indeed, the manipulator 104 can drop the thin flexible waste object 106b near the suction mouth 212 but still over the working area 108 and the airflow caused by the negative pressure in the vacuum conduit 220 draws thin flexible waste object 106b into the suction mouth 212.

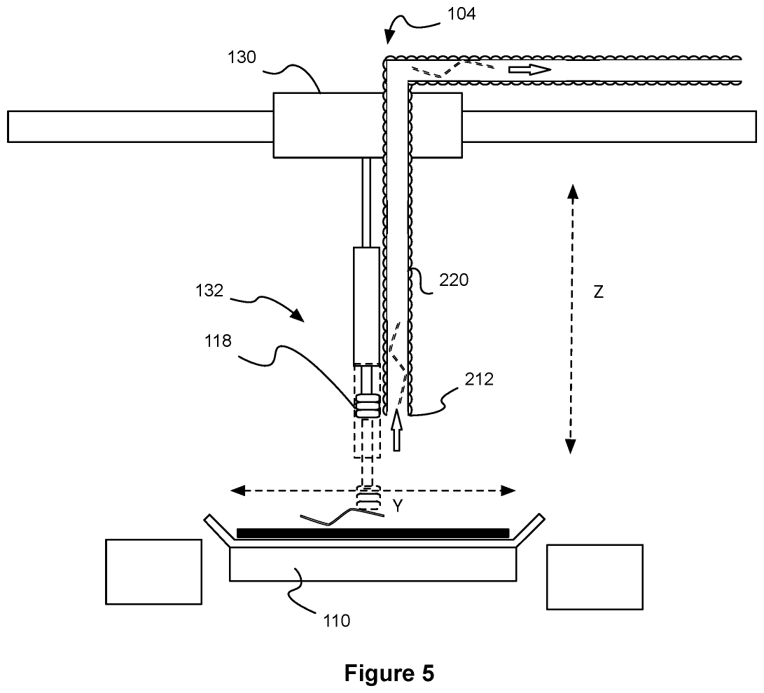

Turning to FIGS. 5 and 6, another example will now be discussed. FIGS. 5 and 6 show a waste sorting robot 100 having a vacuum conduit 220 for sucking waste objects 106b from the working area 108. The example as shown in FIGS. 5 and 6 is the same as shown in the previous Figures except that the suction mouth 212 and vacuum conduit 220 is mounted to the manipulator sled 130. For the purposes of clarity, the vacuum source 214 and the container 216 have not been shown in FIG. 5 or 6.

Since the vacuum conduit 220 is mounted to the manipulator sled 130, the suction mouth 212 and the vacuum conduit 220 are configured to be moved in the Y-axis and the X-axis as the manipulator sled 130 moves the suction gripper 132 in the working area 108. The vacuum conduit 220 and the suction mouth 212 are fixed to the manipulator sled 130. This means that the suction mouth 212 is positioned at a defined distance above the conveyor belt 110.

The vacuum conduit 220 as shown in FIGS. 5 and 6 is flexible and mounted along the horizontal beam 128 and connected to vacuum source 214. In some examples, (not shown) the vacuum conduit 220 can be inserted within the hollow horizontal beam 128. The vacuum conduit 220 is sufficiently flexible to move and flex so as to change shape as the manipulator 104 moves without impeding the movement of the manipulator 104.

As mentioned above, the suction gripper 132 is configured to move in the Z-axis when the first pneumatic actuator 202 extends. This means that the suction gripper 132 is configured to move with respect to the suction mouth 212 in the Z-axis. FIG. 5 shows the suction gripper 132 (in a dotted line outline) extended in the Z-axis direction such that it engages the thin flexible waste object 106b on the conveyor belt 110. FIG. 5 also shows the suction gripper 132 in a retracted position at a defined position above the conveyor 110. When the suction gripper 132 is in the retracted position, the suction cup 118 is positioned adjacent to the suction mouth 212. This means that as the suction cup 118 is moved to the retracted position in the Z-axis, the thin flexible waste object 106b is sucked into the suction mouth 212. The controller 102 can selectively actuate the vacuum source 214 when the controller 102 determines that that suction gripper 132 is in the retracted position.

Since the vacuum conduit 220 and the suction mouth 212 move together with the suction gripper 132 in the X-axis and the Y-axis, the manipulator 104 has a short distance to move the suction gripper 132 to the suction mouth 212. In other words, the manipulator 104 only has to move the suction gripper 132 in the Z-axis in order to present the thin flexible waste object 106b to the suction mouth 212.

In another example, the vacuum conduit 220 and the suction mouth 212 are mounted to the suction gripper 132 such that the suction mouth 212 is configured to move together with the suction cup 118. Accordingly, the suction mouth 212 is always within a defined distance for sucking thin flexible waste object 106b from the suction cup 118. In this case, the controller 102 selectively controls the vacuum source 214 only when the suction cup 118 is gripping the thin flexible waste object 106b. This prevents the vacuum conduit 220 interfering with the picking operation of waste objects 106a, 106c which are not a thin flexible waste object 106b.

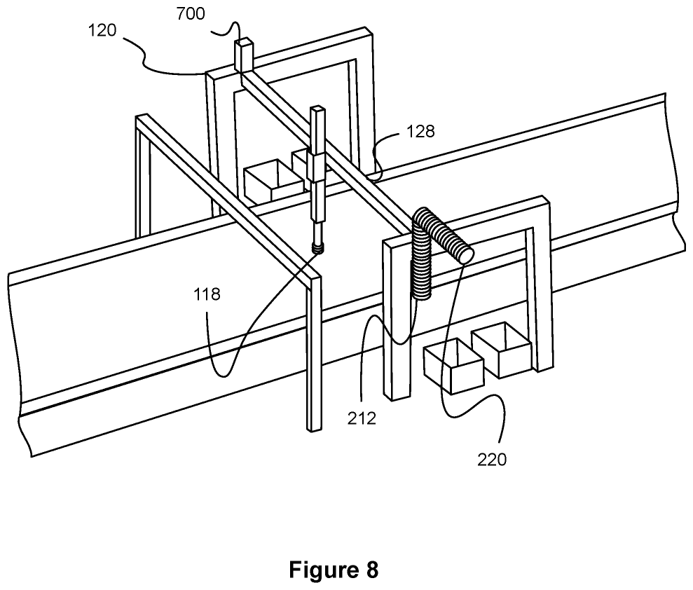

Turning to FIGS. 7 and 8, another example will now be discussed. FIGS. 7 and 8 show a waste sorting robot 100 having a vacuum conduit 220 for sucking waste objects 106b from the working area 108. FIG. 7 shows a side view of the waste sorting robot 100 parallel to the conveyor belt 110 e.g. in a plane parallel with the Z-axis and the X-axis. The example as shown in FIGS. 7 and 8 is the same as shown in the previous FIGS. 5 and 6 except that the suction mouth 212 and vacuum conduit 220 is mounted to the beam sled 700. For the purposes of clarity, the vacuum source 214 and the container 216 have not been shown in FIG. 7 or 8.

Since the vacuum conduit 220 is mounted to the beam sled 700, the suction mouth 212 and the vacuum conduit 220 are configured to be moved in the X-axis but not in the Y-axis as the manipulator sled 130 moves the suction gripper 132 in the working area 108. The vacuum conduit 220 and the suction mouth 212 are fixed to the beam sled 700. This means that the suction mouth 212 is positioned at a defined distance above the conveyor belt 110.

By placing the vacuum conduit 220 and the suction mouth 212 on the beam sled 700, the vacuum conduit 220 and the suction mouth 212 are mounted at the side of conveyor belt 110. This means that the vacuum conduit 220 is required to move less and the manipulator 104 only needs to travel in the Y-axis to move the suction gripper 132 to the suction mouth 212.

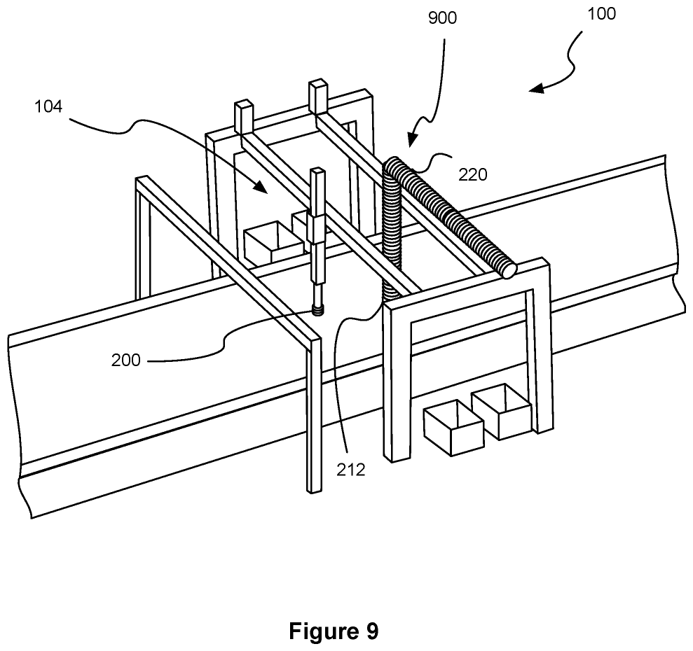

Turning to FIG. 9, another example will now be discussed. FIG. 9 shows a waste sorting robot 100 having a vacuum conduit 220 for sucking waste objects 106b from the working area 108. FIG. 9 is the same as the example as shown in FIG. 6 except that the waste sorting robot 100 comprises a second manipulator 900. The first manipulator 104 is the same as the manipulator 104 as discussed with reference to the previous examples. The second manipulator 900 comprises the same arrangement and system for control and movement of the second manipulator 900 as discussed with reference to the first manipulator 104 above.

The second manipulator 900 comprises a vacuum conduit 220 and the vacuum conduit 220 is the same as discussed with reference to the previous examples. The second manipulator 900 is configured to move the suction mouth 212 within the working area 108 in the X-axis, the Y-axis, and the Z-axis. In this way, the second manipulator 900 is configured to move the suction mouth 212 with a similar functionality as to how the first manipulator 104 moves the suction cup 118 of the suction gripper 132.

This means that the first manipulator 104 and the second manipulator 900 can operate independently where the second manipulator 900 picks thin flexible waste objects 106b and the first manipulator 104 picks other waste objects 106a, 106c which can be thrown into the chute 138. In some examples, the first manipulator 104 can still pick thin flexible waste objects 106b. However, the second manipulator 900 follows the movement of the first manipulator 104 and sucks thin flexible waste objects 106b in to the suction mouth 212 when the suction gripper 132 has gripped a thin flexible waste objects 106b. In this case, the second manipulator 900 moves the suction mouth 212 within a defined distance of the suction cup 118 so that the thin flexible waste object 106b is sucked from the suction cup 118 into the suction mouth 212.

In another example, there is waste sorting robot 100 as shown in FIG. 9 except that the first manipulator 104 is not present. Instead the waste sorting robot 100 only has the second manipulator 900. In this example the waste sorting robot 100 carries out picking operations with only the vacuum conduit 220 and the suction mouth 212. This means that the second manipulator 900 may optionally configured to pick only thin flexible waste objects 106b. In this way, the manipulator 104 is coupled to the vacuum conduit 220 and the manipulator 104 is configured to move the suction mouth 212 within the working area 108 such that the suction mouth 212 is configured to pick the one or more waste objects 106a, 106b, 106c from the working area 108.

Turning to FIG. 10, another example will now be discussed. FIG. 10 shows a waste sorting robot 100 having a vacuum conduit 1000 for sucking waste objects 106b from the working area 108. The vacuum conduit 1000 is the same as discussed in reference to the previous examples except that the size of the vacuum conduit 1000 has been increased to facilitate part of the suction griper 132 and/or the manipulator 104 being mounted within the vacuum conduit 1000. In this example, the vacuum conduit 1000 is configured to surround at least a portion of the suction gripper 132. This means that the suction gripper 132 is mounted within the vacuum conduit 1000. In this way, once the suction gripper 132 has picked a thin flexible waste object 106b, the vacuum conduit 1000 is configured to convey the thin flexible waste object 106b. This function is similar to the arrangement discussed in reference to FIGS. 5 to 8.

The diameter of the suction mouth 1002 of the vacuum conduit 1000 is sufficiently large to permit pivotal movement of the suction gripper 132 with respect to the horizontal beam 128. The pivotal movement of the suction gripper 132 is represented in FIG. 10 with a dotted outline.

In another example which is a variation of the example shown in FIG. 4, the suction mouth 212 of the vacuum conduit 220 extends across the entire working area 108 (instead of adjacent at one position next to the working area 108). This means that the suction mouth 212 is the same distance to the working area 108 along the entire width of the conveyer belt 110 in the X-axis. Accordingly the travel distance of manipulator 104 can be reduced because the manipulator 104 only needs to move in the X-axis.

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. A waste sorting robot comprising:
a frame;
a manipulator movably mounted to the frame and comprising a gripper for interacting with one or more waste objects to be sorted within a working area; and
a conveyor for moving the one or more waste objects towards the working area;
at least one vacuum conduit having a suction mouth and being connected to a vacuum source, the at least one vacuum conduit being configured to convey one or more sorted waste objects from the working area;
wherein the manipulator is configured to move the gripper to a position near the suction mouth after the gripper has picked the one or more waste objects.

2. The waste sorting robot according to claim 1, wherein the suction mouth is configured to move together with the manipulator.

3. The waste sorting robot according to claim 1, wherein the suction mouth is fixed with respect to the frame or the working area.

4. The waste sorting robot according to claim 1, wherein the suction mouth is positioned in a chute configured to receive the one or more waste objects released from the gripper.

5. The waste sorting robot according to claim 1, wherein the suction mouth is positioned above or adjacent to the working area.

6. The waste sorting robot according to claim 1, wherein the suction mouth comprises a diameter similar to or greater than a width or a length of the working area.

7. The waste sorting robot according to claim 1, wherein the suction mouth is fixed with respect to the manipulator or the gripper.

8. The waste sorting robot according to claim 1 wherein the at least one vacuum conduit comprises a flexible portion configured to move together with the manipulator or the gripper.

9. The waste sorting robot according to claim 1, wherein the manipulator is mounted to the frame on a moveable sled configured to move the manipulator across a width of the working area and the suction mouth or a part of the at least one vacuum conduit is mounted to the moveable sled.

10. The waste sorting robot according to claim 1, wherein the manipulator is mounted to the frame on a moveable beam configured to move the manipulator along a length of the working area and the suction mouth or a part of the at least one vacuum conduit is mounted to the moveable beam.

11. The waste sorting robot according to claim 1, wherein the vacuum source is configured to be selectively actuated in dependence of an operational status of the gripper or the manipulator.

12. The waste sorting robot according to claim 1, wherein the vacuum source is configured to be selectively actuated in dependence of one or more parameters of the one or more waste objects picked by the gripper.

13. The waste sorting robot according to claim 1, wherein the vacuum source is configured to be selectively actuated in dependence of a type of the one or more waste objects picked by the gripper.

14. The waste sorting robot according to claim 13, wherein the type of the one or more waste objects is paper, foil, film, threads, fibres, string, or other flexible layer material or flexible thread material.

15. The waste sorting robot according to claim 1, wherein the vacuum source is configured to be actuated when the manipulator or the gripper is actuated.

16. The waste sorting robot according to claim 1, wherein at least part of the gripper or the manipulator is mounted within the suction mouth and the gripper is configured to move from a position with the suction mouth to a position near the working area when picking the one or more waste objects.

17. The waste sorting robot according to claim 1, wherein the waste sorting robot comprises a second manipulator coupled to the at least one vacuum conduit such that the suction mouth moves with respect to the working area.

18. The waste sorting robot according to claim 1, wherein the gripper is a suction gripper.

19. The waste sorting robot according to claim 1, wherein at least a portion of the manipulator is rotatable with respect to the frame such that the gripper is moveable lengthways along the conveyor within the working area.

20. The waste sorting robot according to claim 19, wherein the portion of the manipulator is rotatable about a horizontal axis perpendicular to a longitudinal axis of the conveyor.

21. The waste sorting robot according to claim 19, wherein the manipulator is pivotally mounted on a cross beam over the conveyor.

22. A waste sorting robot comprising:
a frame;
a manipulator moveably mounted to the frame and configured to interact with one or more waste objects to be sorted within a working area; and
a conveyor for moving the one or more waste objects towards the working area;
a vacuum conduit having a suction mouth and being connected to a vacuum source and, the vacuum conduit being configured to convey one or more sorted objects away from the working area;
wherein the manipulator is coupled to the vacuum conduit and configured to move the suction mouth within the working area such that the suction mouth is configured to pick the one or more waste objects from the working area.
